(19) United States
(12) Patent Application Publication
(10) Pub. No.: US 2026/0189600 A1
(43) Pub. Date: Jul. 2, 2026

(54) THREAT DETECTION FOR A COLLECTIVE OF CLIENT COMPUTER NETWORKS TO PROVIDE ACTIVE DEFENSE

(71) Applicant: ProSOC, Inc., San Diego, CA (US)

(72) Inventors: Jordan KNOPP, Anaheim, CA (US); Joseph INGALLS, Pendleton, IN (US); Bradley Houston TAYLOR, Newport Coast, CA (US)

(21) Appl. No.: 19/007,950

(22) Filed: Jan. 2, 2025

(51) Int. Cl. H04L 9/40

(52) U.S. Cl. CPC H04L 63/1441; H04L 63/0236; H04L 63/1425

(57) ABSTRACT

Embodiments of the disclosure are related to a method, apparatus, and system for threat detection for a collective of client computer networks to provide active defense including: collecting network security logs for a client computer network of a collective of client computer networks, the collective of client computer networks including at least one or more other client computer networks; monitoring the network security logs of the client computer network; generating an alert if a condition of the network security logs matches a rule to detect malicious behavior; and based upon the alert, initiating an automated response for the client computer network and for each of the other client computer networks of the collective of client computer networks.

### FIELD

Embodiments of the disclosure are related to computer networks, and more particularly, to threat detection for a collective of client computer networks to provide active defense.

### RELEVANT BACKGROUND

Computer networks and systems have become indispensable tools for modern business. Today terabits of information on virtually every subject imaginable are stored in and accessed across such networks by users throughout the world. Much of this information is, to some degree, confidential and its protection is required. Not surprisingly, various network security monitoring systems have been developed to help uncover attempts by unauthorized persons and/or devices to gain access to computer networks and the information stored therein.

Unfortunately, in present network security monitoring system implementations, when a specific type of malicious activity is identified for a particular client computer network and containment action is provided for that client computer network, other client computer networks that may be affected in the future by the same malicious activity are not protected. This may leave a sufficient window of time for a cyberattack to be carried out on the other client computer networks.

### SUMMARY

Embodiments of the disclosure are related to a method, apparatus, and system for including: collecting network security logs for a client computer network of a collective of client computer networks, in which, the collective of client computer networks include at least one or more other client computer networks; monitoring the network security logs of the client computer network; generating an alert if a condition of the network security logs matches a rule to detect malicious behavior; and based upon the alert, initiating an automated response for the client computer network and for each of the other client computer networks of the collective of client computer networks.

In one embodiment, the network security logs are sent to a security information and event management (SIEM) database and the network security logs of the SIEM database are monitored by a rules and alert engine to determine if the network security logs match a rule to detect malicious behavior to cause the generation of the alert. In one embodiment, the automated response for the client computer network comprises blocking an IP address at the firewall of the client computer network. In one embodiment, the automated response for each client computer network of the other client computer networks of the collective of client computer networks comprises blocking the IP address at the firewall of each other client computer network of the collective of client computer networks. In one embodiment, the automated response for the client computer network further comprises adding the IP address to a collective blocklist stored on an active defense server. In one embodiment, the automated response for the client computer network further comprises blocking the IP address at the firewall of the client computer network based upon the IP address added to the collective blocklist stored on the active defense server. In one embodiment, the automated response for each of the other client computer networks of the collective of client computer networks further comprises each other client computer network checking the collective blocklist of the active defense server for the added IP address and based upon the added IP address, blocking the added IP address at the firewall of each of the other client computer networks of the collective of client computer networks, respectively. In one embodiment, the collective of client computer networks comprises client computer networks of a same sector, client computer networks of predefined size, or all client computer networks. In one embodiment, the client computer networks of the same sector include at least one of healthcare computer networks, finance computer networks, or government computer networks. In one embodiment, the client computer networks of predefined size include client computer networks based upon revenue size of the client associated with the client computer network including small revenue, medium revenue, or large revenue. In one embodiment, the collective of client computer networks, comprise client computer networks that are registered with a threat detection computer network system to provide active defense for a collective of client computer networks.

These and other aspects will become more fully understood upon a review of the detailed description, which follows. Other aspects, features, and examples will become apparent to those of ordinary skill in the art, upon reviewing the following description of examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices.

### BRIEF DESCRIPTION OF THE DRAWINGS

FIG. 1 is a flowchart illustrating an example method for threat detection for a collective of client computer networks to provide active defense, according to one embodiment of the disclosure.

FIG. 2 is a diagram illustrating an example of network security monitoring system that implements an active defense for a collective of client computer networks, according to one embodiment of the disclosure.

FIG. 3 is a diagram illustrating an example for detecting malicious activity in a particular client computer network and response by an active defense collective network security monitoring system, according to one embodiment of the disclosure.

FIG. 4 illustrates examples of possible events that can be monitored as network security logs by a rules and alert engine, according to one embodiment of the disclosure.

FIG. 5 is a diagram illustrating a example for detecting malicious activity in a particular client computer network and response by an active defense collective network security monitoring system, according to one embodiment of the disclosure.

FIG. 6 is a diagram of previously described examples of collectives of client computer networks, according to one embodiment of the disclosure.

FIG. 7 is a block diagram illustrating an example computing device, according to embodiments of the disclosure.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments. Embodiments of disclosure described herein may relate to functionality implemented across multiple devices. Obvious communications (e.g., transmissions and receipts of information) between the devices may have been omitted from the description in order not to obscure the disclosure.

Embodiments of the disclosure are related to a method, apparatus, and system for including: collecting network security logs for a client computer network of a collective of client computer networks, in which, the collective of client computer networks include at least one or more other client computer networks; monitoring the network security logs of the client computer network; generating an alert if a condition of the network security logs matches a rule to detect malicious behavior; and based upon the alert, initiating an automated response for the client computer network and for each of the other client computer networks of the collective of client computer networks.

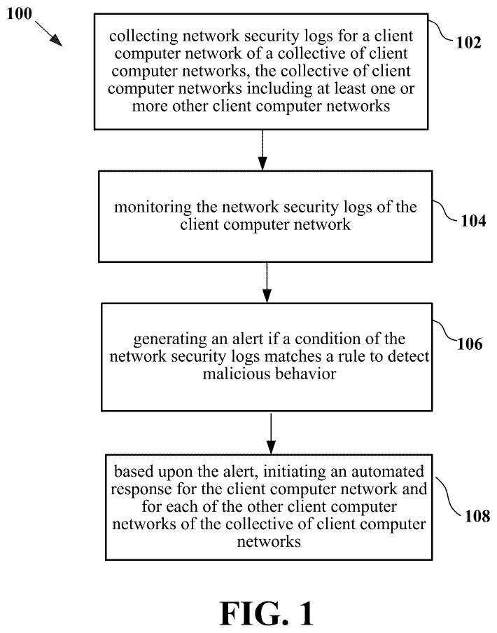

Referring to FIG. 1, FIG. 1 is a flowchart 100 illustrating an example method for threat detection for a collective of client computer networks to provide active defense, according to one embodiment of the disclosure.

At block 102, network security logs are collected for a client computer network of a collective of client computer networks, in which, the collective of client computer networks include at least one or more other client computer networks. At block 104, network security logs of the client computer network are monitored. Next, at block 106, an alert is generated if a condition of the network security logs matches a rule to detect malicious behavior. Then, at block 108, based upon the alert, an automated response for the client computer network and for each of the other client computer networks of the collective of client computer networks is initiated.

As will be described in more detail hereafter, a collective of client computer networks (e.g., that include the initial client computer network to which the malicious activity has been detected) will each automatically receive the same automatic containment action for their computer network (as did the initial client computer network), even in the absence of the particular malicious activity for their particular computer network. In this way, the network security monitoring system implements proactive security for a collective of client computer networks.

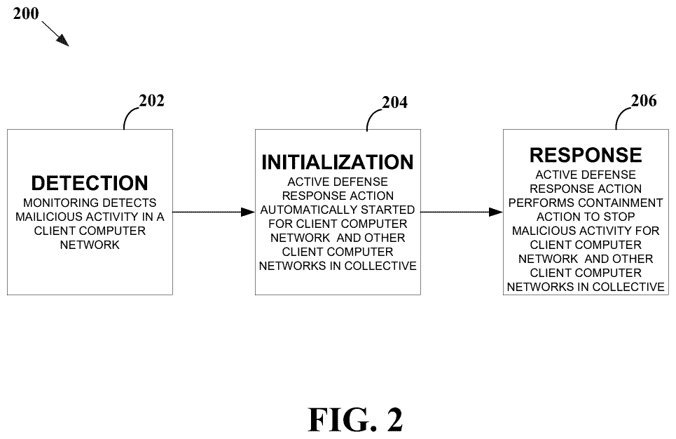

With brief additional reference to FIG. 2, FIG. 2 is a diagram illustrating an example of network security monitoring system 200 that implements an active defense for a collective of client computer networks (e.g., hereinafter referred to active defense collective network security monitoring system 200), according to one embodiment of the disclosure.

For example, at detection block 202, active defense collective network security monitoring system 200 provides detection monitoring, in which, monitoring detects a malicious activity in a particular client computer network. Next, at initialization block 204, active defense collective network security monitoring system 200 provides an active defense response action that is automatically started for the initial client computer network to which the malicious activity has been detected and other client computer networks that are in the collective of client computer networks. Further, at response block 206, active defense collective network security monitoring system 200 provides an active defense response action that performs containment action to stop the malicious activity for the initial client computer network to which the malicious activity has been detected and other client computer networks that are in the collective of client computer networks. At response block 206, active defense collective network security monitoring system 200 performs the action of a perimeter-block to block the IP address at the firewall or web application firewall (WAF) of the initial client computer network to which the malicious activity has been detected and other client computer networks that are in the collective of client computer networks.

It should be appreciated that a collective of client computer networks may include client computer networks of a same sector, client computer networks of predefined size, or all client computer networks. As an example, client computer networks of the same sector may include: healthcare computer networks, finance computer networks, or government computer networks, etc. As other examples, client computer networks of predefined size may include client computer networks based upon revenue size of the client associated with the client computer network including: small revenue, medium revenue, or large revenue, etc. The active defense collective network security monitoring system may itself organize client computer networks into a collective of client computer networks for active defense or clients themselves (e.g., on a subscription price basis) may select to have their client computer network to be included a collective of client computer networks for active defense. Also, as has been described, the active defense collective network security monitoring system may decide to have all client computer networks included in the collective of client computer networks. It should be appreciated that these are just example types of client computer networks that may be organized into a collective of client computer networks and that any organization type is possible.

As has been described, in previous implementations, a specific type of malicious activity is identified for a particular client computer network and containment action is provided just for that client computer network, which is reactive, and avoids other client computer networks that may be affected in the future by the same malicious activity and may need protections. In the embodiment disclosed herein, a collective of client computer networks (e.g., that include the initial client computer network to which the malicious activity has been detected) will each automatically receive the same automatic containment action for their computer network (as did the initial client computer network), even in the absence of the particular malicious activity for their particular client computer network by the active defense collective network security monitoring system 200. In this way, the active defense collective network security monitoring system 200 implements proactive security for a collective of client computer networks.

As has been described, in some examples, customers of the active defense collective network security monitoring system 200 may subscribe their client computer network to a collective of client computer networks (e.g., same sector, similar size, all client computer networks, etc.), such that, they automatically receive the same automatic containment action for their computer network, when a client computer network in their collective of client computer networks has malicious activity detected. As an example of a same sector implementation, a healthcare client computer network may subscribe to the “same sector” to receive all containment actions of other healthcare client computer networks. It should be appreciated that this is just one example of a client computer network that may be organized into a collective of client computer networks and that a wide variety are possible.

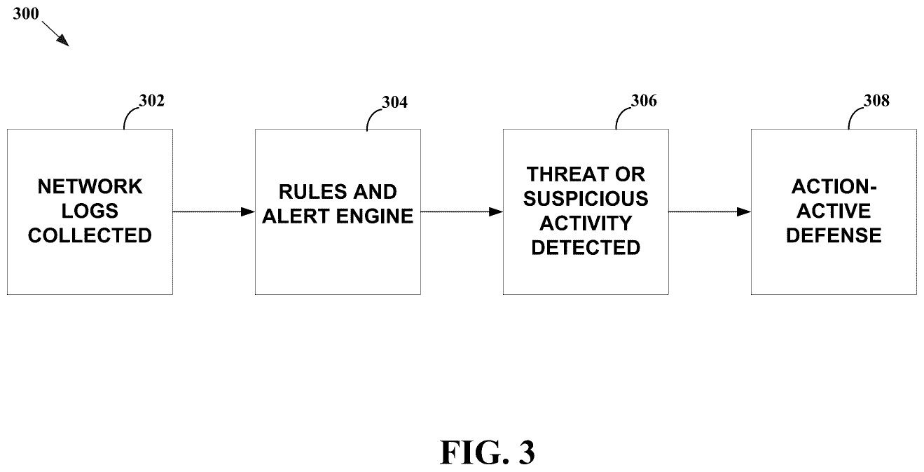

With brief additional reference to FIG. 3, FIG. 3 is a diagram illustrating a further example for detecting malicious activity in a particular client computer network and response by an active defense collective network security monitoring system 300, according to one embodiment of the disclosure. As shown in FIG. 3, network security logs 302 are collected from the client computer network and may be sent to and processed by a rules and alert engine 304 to determine whether a threat or suspicious activity has been detected 306 for the client computer network. In particular, the rules and alert engine 304 is used to monitor the network security logs and triggers an alert, if the rules and alert engine 304 determines whether a condition of the network security logs matches a correlation rule or an anomaly is determined to meet a predefined condition. When an alert is generated, at block 308, an active defense action is initiated to contain the threat. In one embodiment, the active defense action includes the active defense collective network security monitoring system providing an active defense response action that performs containment action to stop the malicious activity for the initial client computer network to which the malicious activity has been detected and other client computer networks that are in the collective of client computer networks. For example, the active defense collective network security monitoring system may perform the action of a perimeter-block to block the IP address at the firewall or web application firewall (WAF) of the initial client computer network to which the malicious activity has been detected and other client computer networks that are in the collective of client computer networks.

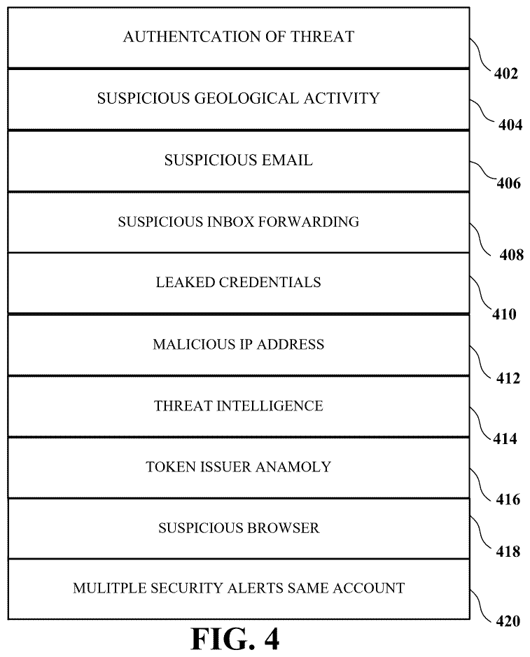

With brief reference to FIG. 4, FIG. 4 illustrates examples of possible events that can be monitored as network security logs by rules and alert engine 304 and can be analyzed to determine if a correlation rule is matched or an anomaly is determined to meet a predefined condition to trigger an alert: authentication of a threat from client computer network 402, suspicious geolocation authentication 404, suspicious emails 406, suspicious inbox forwarding 408, leaked credentials 410, malicious IP address 412, threat intelligence from client computer network 414, token issuer anomaly 416, suspicious browser 418, multiple security alerts for same account from client computer network 420. It should be appreciated that any of these events can be used for the detection of matches of correlation rules or anomalies meeting predefined conditions and that any of these events may be determined based on searches by the rules and alerts engine 304. It should be appreciated that these are just examples, and that a wide variety of monitored suspicious or malicious activities in client computer networks or cloud platforms being monitored by scanning the network security logs may be utilized.

As has been described, the active defense collective network security monitoring system provides preventative security to client computer networks based on their association with a collective of client computer networks. As has been described, in the active defense collective network implementation, an automated response is triggered when malicious activity is detected. The active defense collective network implementation is configured to extend the perimeter type of active defense. In one embodiment, the active defense response (e.g., for perimeter type) is to block an IP address at the firewall or WAF. This response is initiated when suspicious or malicious activity is detected. As part of threat detection and response, network security logs are collected from client environments for security monitoring purposes. For example, in one example embodiment, these security logs may be collected via a Security Event and Information Management (SIEM) platform, where they can be searched, analyzed, and enriched. As an example, to provide security monitoring, regularly scheduled jobs run at frequent intervals in the SIEM to look for specific condition matches. These jobs may be referred to as rules, and they correlate network security logs to identify defined patterns. When a rule finds a match, it typically generates an alert that is sent to a client network to describe what is found and explain what they should do about it. Further, these rules may trigger the active defense response previously described.

It should be appreciated that due to the possible disruption in client computer networks, only certain rules may be configured to trigger the active defense response in order to avoid negative computer network implications. As an example of a negative computer network implication, consider active defense triggering on a false positive to block the IP address of GOOGLE or some other popular site or service. This could interrupt business for a client environment. As such, the rules configured to take an active defense action may be limited in number and have a high confidence in their correctness. As another example, consider the following rule: massive secure shell (SSH) access from a Blacklisted IP Address. In this rule, the rule implementation is searching for a high number of access attempts via SSH, and also looking to confirm that the source IP address making these access attempts is blacklisted. A blacklisted IP address is one that appears in threat intelligence databases or lists because it has been observed to perform suspicious or malicious activity. Including a reputation check on the IP address in this manner allows for a higher confidence in the rule, so taking an automated action to block the source IP address is a safer response action. When, active defense is initiated for perimeter, the IP address is passed to an automation system to perform the block and the automation server provides this IP address (as well as the specific client) to an active defense server. The active defense server will be described in more detail hereafter.

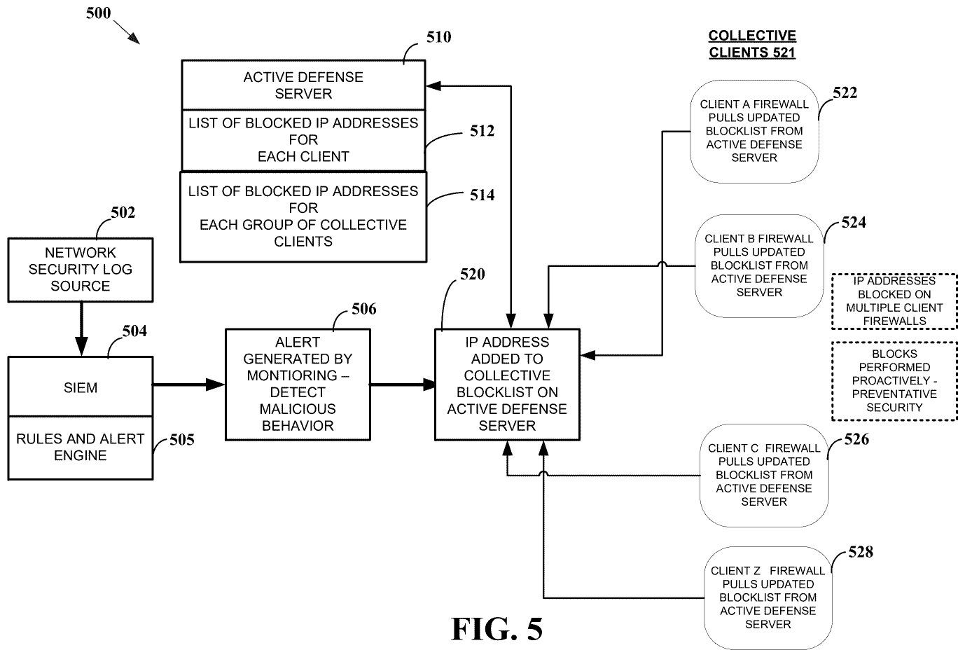

With additional reference to FIG. 5, FIG. 5 is a diagram illustrating a further example for detecting malicious activity in a particular client computer network and response by an active defense collective network security monitoring system 500, according to one embodiment of the disclosure. Network security logs may be collected by a network security log source 502 for a client computer network of a collective of client computer networks, in which, the collective of client computer networks include at least one or more other client computer networks. As one example, as will be described in more detail hereafter, network security logs may be collected for client computer network A 522 of a collective of client computer networks 521 (e.g., collective clients 521) of which client network A 522 is included in, along with other client computer networks (e.g., client B 524, client C 526, client Z 528, etc.).

In one embodiment, the network security logs are sent to a security information and event management (SIEM) database 504 and the network security logs of the SIEM database are monitored by a rules and alert engine 505 to determine if the network security logs match a rule to detect malicious behavior to cause the generation of an alert. It should be appreciated that the rules and alert engine can be implemented at the SIEM database 504 or at a different location. Also, the SIEM database 504 may be implemented by the active defense collective network security monitoring system 500, or at the client computer network itself, or at another location.

Next, at block 506, an alert is generated if a condition of the network security logs matches a rule to detect malicious behavior based on monitoring. As has been described, based upon the alert, an automated response for the client computer network and for each of the other client computer networks of the collective of client computer networks is initiated.

As has been described, in one embodiment, the automated response for the client computer network comprises blocking an IP address at the firewall of the client computer network. Also, as has been described, in one embodiment, the automated response for each client computer network of the other client computer networks of the collective of client computer networks comprises blocking the IP address at the firewall of each other client computer network of the collective of client computer networks. Examples of these implementations will be described hereafter.

In one embodiment, to achieve this functionality, as shown at block 520, the automated response for the client computer network further comprises adding the IP address to a collective blocklist 514 stored on an active defense server 510. As shown in FIG. 5, an active defense server 510 includes a list of blocked IP addresses for each client 512 and a list blocked IP addresses for each group of collective clients 514. It should be appreciated that because there may be multiple groups of collective clients there may be a list of blocked IP addresses for each group of collective clients.

Within the active defense server 510, each client has their own list of IP addresses that should be blocked 512. Client firewalls are configured to periodically reach out to this active defense server 510 and check for any updates made to the list. If there are any new IP addresses added to this list, the client firewall will update its local copy of the list of IP addresses to block. In some aspects, client lists may be kept separate from each other in two ways: either the firewall authenticates to the active defense server, and that authentication provides the basis for which client list they will see, or the client firewall uses a URL with a unique GUID, at which point the active defense server will provide them their specific list.

In block 514, the lists of IP addresses to block are no longer client-specific, but are instead, a shared list that represents all observed malicious IP addresses in the collective of clients (e.g., referred to as active defense collective). Therefore, block 514 includes a list of blocked IP addresses for each group of collective clients 514 (e.g., group of healthcare computer networks, group of finance computer networks, group of government computer networks, group of all client computer networks, etc.). It should be appreciated that because there may be multiple groups of collective clients there may be a list of blocked IP addresses for each group of collective clients.

As will be described, in one embodiment, the automated response for the client computer network (at which the malicious behavior was detected) includes blocking the IP address at the firewall of the client computer network based upon the IP address added to the collective blocklist 514 stored on the active defense server 510. It should be appreciated that as shown in the example of collective clients 521, the client firewalls of the collective clients continuously pull the updated blocklist 514 for their collective from the active defense server 522. Therefore, as an example, if client A has malicious behavior detected, the IP address for this malicious address is added to the list of blocked IP addresses for the group of collective clients 514 that client A is included in, and client A firewall 522 pulls the updated blocklist from the active defense server 510 and blocks this IP address.

It should be appreciated that there may be any number of collective clients 521. As an example, FIG. 5, shows client computer networks A, B, C...Z 522, 524, 526, and 528 illustrating that there can be any number of client computer networks, and each of the firewalls for the clients continuously pull the updated blocklist 514 for their collective(s) from the active defense server 510.

Further, as will be described, in one embodiment, the automated response for each of the other client computer networks of the collective of client computer networks 521 further includes each other client computer network checking the collective blocklist 514 of the active defense server 510 for the added IP address and based upon the added IP address, blocking the added IP address at the firewall of each of the other client computer networks of the collective of client computer networks, respectively. Therefore, as an example, if client A has malicious behavior detected, the IP address for this malicious activity is added to the list of blocked IP addresses for the group of collective clients 514 that client A is included in. Further, for example, if clients B and C are in the same collective as client A, client B firewall 524 and client C firewall 526 pull the updated blocklist of their collective 514 from the active defense server 510 and blocks this IP address for client computer networks B and C, respectively.

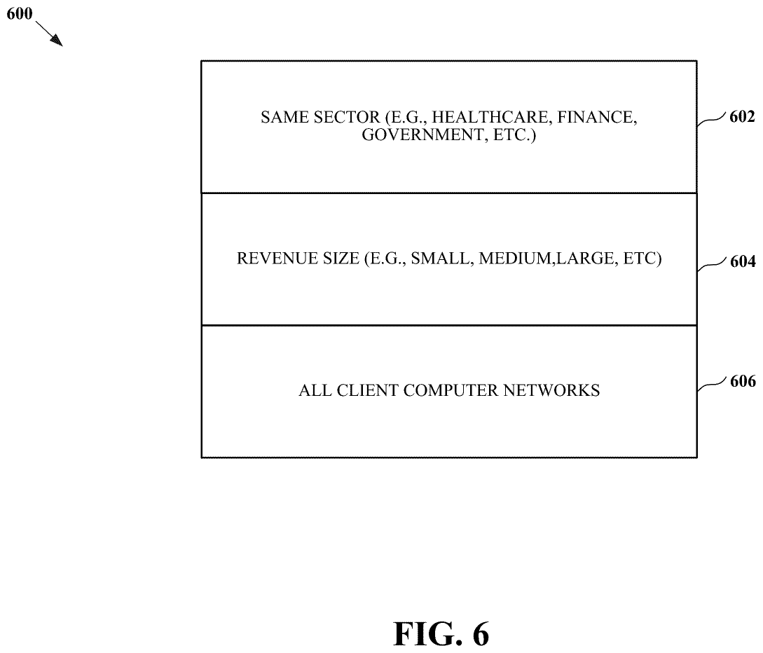

With brief reference to FIG. 6, a diagram 600 of previously described examples of collectives of client computer networks, is shown, which may include client computer networks of a same sector 602, client computer networks of predefined size 604, or all client computer networks 606. As an example, client computer networks of the same sector may include: healthcare computer networks, finance computer networks, or government computer networks, etc. As other examples, client computer networks of predefined size may include client computer networks based upon revenue size of the client associated with the client computer network including: small revenue, medium revenue, or large revenue, etc.

The active defense collective network security monitoring system 500 may itself organize client computer networks into a collective of client computer networks for active defense or clients themselves (e.g., on a subscription price basis) may select to have their client computer network to be included a collective of client computer networks for active defense. Also, as has been described, the active defense collective network security monitoring system 500 may decide to have all client computer networks included in the collective of client computer networks. It should be appreciated that these are just example types of client computer networks that may be organized into a collective of client computer networks and that any organization type is possible. Also, as has been previously described, in some examples, customers of the active defense collective network security monitoring system 200 may subscribe their client computer network to a collective of client computer networks (e.g., same sector, similar size, all client computer networks, etc.), such that, they automatically receive the same automatic containment action for their computer network, when a client computer network in their collective of client computer networks has malicious activity detected. Therefore, client computer networks may register or subscribe to the active defense collective network security monitoring system 500 to provide active defense for a collective of client computer networks.

As an example of a same sector implementation, a finance client computer network may be subscribed to receive all containment actions of other finance client computer networks in the collective of finance client computer networks. As an example, client computer networks A, B, and C, may all subscribe to a collective of finance client computer networks and may share a list of blocked IP addresses for the collective of finance client computer networks 514. Therefore, as an example, if client A has malicious behavior detected, the IP address for this malicious address is added to the list of blocked IP addresses for the finance group of collective clients 514 that client A is included in that also includes finance client computer network B and finance client computer network C. Therefore, as an example, if client A has malicious behavior detected, the IP address for this malicious address is added to the list of blocked IP addresses for the finance group of collective clients 514 that client A is included in, and client A firewall 522 pulls the updated blocklist from the active defense server 510 and block this IP address. Further, for example, if clients B and C are in the same finance group collective as client A, client B firewall 524 and client C firewall 526 pull the updated blocklist of their finance group collective 514 from the active defense server 510 and blocks this IP address for finance client computer networks B and C, respectively. It should be appreciated that this is just one example of a client computer network that may be organized into a collective of client computer networks and that a wide variety of other types of collectives of client computer networks are possible.

In this example, blocks are performed proactively for preventative security. In particular, the IP addresses are blocked across multiple client firewalls. As an example, a collective of client computer networks (e.g., a subscribed finance collective—Clients A, B, and C), can be provided containment action for each of their computer networks. In this example, Client A is provided containment action (e.g., blocking the IP address) based upon the malicious activity detected for Client A itself, and Clients B and C are also provided containment action (e.g., blocking the IP address) even in the absence of the particular malicious activity for their particular client computer network (Client B and Client C) by the active defense collective network security monitoring system 500. In this way, the active defense collective network security monitoring system 500 implements proactive security for a collective of client computer networks (e.g., in this example a collective of finance computer networks).

It should be appreciated that this example of a sector-based collective group of finance computer networks is just one example. There are multitude of different types of collective grouping of computer network possibilities based on different sectors (e.g., healthcare, government, etc.), revenue sizes of client computer networks (e.g., small, medium, large, etc.), as well as wide variety of other types possible collective grouping of computer networks.

As further examples of how a collective list may be defined are, including but not limited to:
1) All Clients in the same sector (e.g. all Healthcare clients, all Finance clients, all Government clients, etc.)—Rationale: cybercriminals will often target a specific sector, as the target or goal of the attack is usually achievable at many companies that operate within the same sector;
2) All Clients of a certain size (small, medium, large, etc.)—Rationale: company size, when measured by something like revenue, can determine what types of attackers will target it;
All Clients monitored by the collective network security monitoring system 500—Rationale: shared protection across all clients provides a scalable value proposition (i.e. the more clients in a Collective, the more protection it provides).

As previously described, these are just examples and a wide variety of other types possible collective grouping of computer networks may be utilized.

As has been described, a benefit of collective network security monitoring system 500 is that if a client has an Active Defense block performed (e.g., on the perimeter) then it is added to the Collective group list(s). As has been described, in this Active Defense Collective implemented by collective network security monitoring system 500, a client can receive this response action if the IP address is seen performing malicious activity in any client network of the Collective group, not just their own. The consequence of this is that they can receive the block before any cyberattacks are observed in their network by the IP address. This provides the client a preventative security measure to stop attacks before they are even attempted.

It should be noted that a primary distinction to draw between an Active Defense and an Active Defense Collective implementation is that in Active Defense, a client only receives a response action (an IP address being blocked) if that specific IP address is seen performing malicious activity in their network and that IP address is added to the list of blocked IP address for each client 512. In Active Defense Collective, a client can receive this response action if the IP address is seen performing malicious activity in any client network, not just their own.

In a purely Active Defense example, assume Client A is “ACME Healthcare.” When Active Defense triggers for this client, the IP address to block is added to the client-specific blocklist 512 on the Active Defense server 510. Client A/ACME Healthcare's firewall(s) repeatedly check the Active Defense server 510 for changes made to the list of IP addresses for Client A 512, and, when a change is observed, Client A firewall(s) update their list of IP addresses to block, and the block is then completed.

Another example will be described hereafter for Active Defense Collective implementation. For simplification, assume that the Collective group is described as “Healthcare” referring to all clients monitored by the active defense collective network security monitoring system 500 within the healthcare industry. As an example, Client A may be “ACME Healthcare” and Client A/ACME Healthcare selects or subscribes to be part of the Active Defense Collective for “Healthcare”. In this way, Client A/ACME Healthcare is added to the Collective (Healthcare) blocklist 514 on the active defense server 510.

Continuing with an Active Defense Collective example, in this example illustration, Client A/ACME Healthcare is part of Active Defense Collective list for Healthcare 514. In this example, Client B and Client C may also be part of the Active Defense Collective list for Healthcare 514. In this example, Active Defense Collective is implemented by the active defense collective network security monitoring system 500 for Client A/ACME Healthcare by generating an alert based on malicious behavior detected at Client A/ACME Healthcare such that the IP address associated with the malicious behavior is added (block 520) to the Active Defense Collective list for Healthcare 514. Client A/ACME Healthcare's firewall(s) 522 repeatedly checks the Active Defense server 510 for changes made to the Collective list of IP addresses for Healthcare 514. When this change is observed, Client A/ACME Healthcare's firewall(s) 522 update their list of IP addresses to block, and the block is then completed. Further, all other clients in the Healthcare Collective (e.g., Client B and Client C) also have their firewalls repeatedly checking the Active Defense server 510 for changes made to the list of IP addresses 514. So all other clients in the Collective (e.g., Client B and Client C) will also receive this block, because they are all using the same list 514 on the Active Defense server 510. Therefore, Client B firewall 524 and Client C firewall 526 update their list of IP addresses to block, and the block is then completed for these clients (clients B and C) of the Active Defense Collective list for Healthcare 514 as well.

It should be noted that, in this example, adding this IP address to the client-specific list for ACME Healthcare is avoided. Firewalls do not always have the ability to consult multiple lists, and this implementation also ensures that there isn't a duplicate block performed (i.e. if ACME Healthcare firewall was looking at both their client-specific list and the Collective list that they are a part of).

Conversely, when Active Defense triggers for a client other than Client A/ACME Healthcare within the Healthcare Collective (e.g., Client B or Client C), the IP address to block would be added to the Collective blocklist 514 on the Active Defense server 510. Then, since Client A/ACME Healthcare's firewall(s) 522 repeatedly check the Active Defense server 510 for changes made to the Healthcare Collective list 514, Client A/ACME Healthcare would then process this block in the same way, even though there was no actual detection or Active Defense initiation based on detections within their environment. In this way, Active Defense Collective is a proactive form of security that takes preventative measures to protect the networked environment from cyber-attacks.

It should be appreciated that this example of one type of sector-based collective group of healthcare computer networks is just one example. There are a multitude of different types of collective grouping of computer network possibilities based on different sectors (e.g., finance, government, etc.), revenue sizes of client computer networks (e.g., small, medium, large, etc.), as well as wide variety of other types possible collective grouping of computer networks.

As has been described, a collective of client computer networks can be defined and can perform containment action for each of the particular computer networks of the collective, even in the absence of the particular malicious activity for their own particular computer network, based on being part of the collective. In this way, the network security monitoring system implements proactive security for a collective of client computer networks. As has been described, in previous implementations, a specific type of malicious activity is identified for a particular client computer network and containment action is provided just for that client computer network, which is reactive, and avoids other client computer networks that may be affected in the future by the same malicious activity and may need protections. As previously disclosed, embodiments of disclosure describe a collective of client computer networks (e.g., that include the initial client computer network to which the malicious activity has been detected) that will each automatically receive the same automatic containment action for their computer network (as did the initial client computer network), even in the absence of the particular malicious activity for their particular client computer network by the active defense collective network security monitoring system. In this way, the active defense collective network security monitoring system implements proactive security for a collective of client computer networks. In particular, the active defense collective network security monitoring system is a proactive form of security that takes preventative measures to protect the networked environment from cyber-attacks. Blocks of IP addresses may be performed proactively for preventative security across multiple client firewalls.

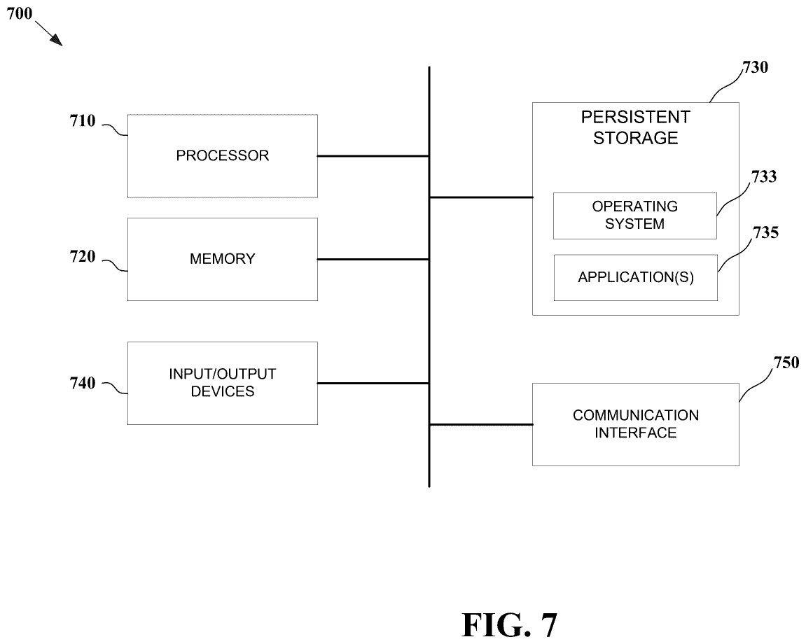

Referring to FIG. 7, a block diagram illustrating an example computing device 700 according to embodiments of the disclosure is shown. The device may comprise a processor 710, a memory 720, a persistent storage 730, one or more input/output devices 740, and a communication interface 750. The memory 720 may comprise a random access memory (RAM) and a read-only memory (ROM). An operating system 733 and one or more applications 735 may be stored in the persistent storage 730. The code stored in the persistent storage 730 may be loaded into the memory 720 and executed by the processor 710. When code is executed by the processor 710, the device 700 may perform one or more functions based on the code, such as the operating system 733 or the applications 735. The one or more applications 735 may be adapted for various functions and purposes. The communication interface 750 may enable the device 700 to communicate with one or more other devices using one or more known wired or wireless communication protocols.

Merely by way of example, one or more procedures described with respect to the method(s) previously described may be implemented as code and/or instructions executable by a device (and/or a processor within a device). A set of these instructions and/or code may be stored on a non-transitory computer-readable storage medium, such as the persistent storage device(s) 730 described above. In some cases, the storage medium might be incorporated within a computer system, such as the device 700. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by the device 700 and/or might take the form of source and/or installable code, which, upon compilation and/or installation on the device 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

It should be appreciated that aspects of the previously described processes may be implemented in conjunction with the execution of instructions by a processor (e.g., processor 710) of a device (e.g., device 700), as previously described. Particularly, circuitry of the devices, including but not limited to processors, may operate under the control of a program, routine, or the execution of instructions to execute methods or processes in accordance with embodiments described (e.g., the processes and functions of FIGS. 1-6). For example, such a program may be implemented in firmware or software (e.g. stored in memory and/or other locations) and may be implemented by processors and/or other circuitry of the devices. Further, it should be appreciated that the terms device, processor, microprocessor, circuitry, controller, SoC, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, LTE Advanced, 4G, 5G, 6G, CDMA, TDMA, OFDM, OFDMA, WiMAX, Wi-Fi, Bluetooth, Zigbee, LoRA, and Narrowband-IoT (NB-IoT). Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a virtual reality or augmented reality device, a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method for threat detection for a collective of client computer networks to provide active defense comprising:
collecting network security logs for a client computer network of a collective of client computer networks, the collective of client computer networks including at least one or more other client computer networks;
monitoring the network security logs of the client computer network;
generating an alert if a condition of the network security logs matches a rule to detect malicious behavior; and
based upon the alert, initiating an automated response for the client computer network and for each of the other client computer networks of the collective of client computer networks.

2. The method of claim 1, wherein the network security logs are sent to a security information and event management (SIEM) database and the network security logs of the SIEM database are monitored by a rules and alert engine to determine if the network security logs match a rule to detect malicious behavior to cause the generation of the alert.

3. The method of claim 1, wherein the automated response for the client computer network comprises blocking an IP address at the firewall of the client computer network.

4. The method of claim 3, wherein the automated response for each client computer network of the other client computer networks of the collective of client computer networks comprises blocking the IP address at the firewall of each other client computer network of the collective of client computer networks.

5. The method of claim 4, wherein the automated response for the client computer network further comprises adding the IP address to a collective blocklist stored on an active defense server.

6. The method of claim 5, wherein the automated response for the client computer network further comprises blocking the IP address at the firewall of the client computer network based upon the IP address added to the collective blocklist stored on the active defense server.

7. The method of claim 5, wherein the automated response for each of the other client computer networks of the collective of client computer networks further comprises each other client computer network checking the collective blocklist of the active defense server for the added IP address and based upon the added IP address, blocking the added IP address at the firewall of each of the other client computer networks of the collective of client computer networks, respectively.

8. The method of claim 3, wherein the collective of client computer networks comprises client computer networks of a same sector, client computer networks of predefined size, or all client computer networks.

9. The method of claim 8, wherein the client computer networks of the same sector include at least one of healthcare computer networks, finance computer networks, or government computer networks.

10. The method of claim 8, wherein the client computer networks of predefined size include client computer networks based upon revenue size of the client associated with the client computer network including small revenue, medium revenue, or large revenue.

11. The method of claim 1, wherein the collective of client computer networks, comprise client computer networks that are registered with a threat detection computer network system to provide active defense for a collective of client computer networks.

12. A non-transitory computer-readable medium comprising code which, when executed by a processor, causes the processor to execute a method for threat detection for a collective of client computer networks to provide active defense comprising:
collecting network security logs for a client computer network of a collective of client computer networks, the collective of client computer networks including at least one or more other client computer networks;
monitoring the network security logs of the client computer network;
generating an alert if a condition of the network security logs matches a rule to detect malicious behavior; and
based upon the alert, initiating an automated response for the client computer network and for each of the other client computer networks of the collective of client computer networks.

13. The non-transitory computer-readable medium of claim 12, wherein the network security logs are sent to a security information and event management (SIEM) database and the network security logs of the SIEM database are monitored by a rules and alert engine to determine if the network security logs match a rule to detect malicious behavior to cause the generation of the alert.

14. The non-transitory computer-readable medium of claim 12, wherein the automated response for the client computer network comprises blocking an IP address at the firewall of the client computer network.

15. The non-transitory computer-readable medium of claim 14, wherein the automated response for each client computer network of the other client computer networks of the collective of client computer networks comprises blocking the IP address at the firewall of each other client computer network of the collective of client computer networks.

16. The non-transitory computer-readable medium of claim 15, wherein the automated response for the client computer network further comprises adding the IP address to a collective blocklist stored on an active defense server.

17. The non-transitory computer-readable medium of claim 16, wherein the automated response for the client computer network further comprises blocking the IP address at the firewall of the client computer network based upon the IP address added to the collective blocklist stored on the active defense server.

18. The non-transitory computer-readable medium of claim 16, wherein the automated response for each of the other client computer networks of the collective of client computer networks further comprises each other client computer network checking the collective blocklist of the active defense server for the added IP address and based upon the added IP address, blocking the added IP address at the firewall of each of the other client computer networks of the collective of client computer networks, respectively.

19. The non-transitory computer-readable medium of claim 14, wherein the collective of client computer networks comprises client computer networks of a same sector, client computer networks of predefined size, or all client computer networks.

20. The non-transitory computer-readable medium of claim 19, wherein the client computer networks of the same sector include at least one of healthcare computer networks, finance computer networks, or government computer networks.
